(19) United States
(12) Patent Application Publication
(10) Pub. No.: US 2022/0179147 A1
(43) Pub. Date: Jun. 9, 2022

(54) PATTERNED BACKLIGHT FOR DISPLAY PANEL

(71) Applicant: Facebook Technologies, LLC, Menlo Park, CA (US)

(72) Inventors: Fenglin Peng, Redmond, WA (US); Ying Geng, Bellevue, WA (US); Alexander Koshelev, Redmond, WA (US); Giuseppe Calafiore, Redmond, WA (US); Jacques Gollier, Sammamish, WA (US); Yun-Han Lee, Redmond, CA (US); Lu Lu, Kirkland, WA (US); Linghui Rao, Bothell, WA (US)

(21) Appl. No.: 17/321,121

(22) Filed: May 14, 2021

Related U.S. Application Data
(60) Provisional application No. 63/121,494, filed on Dec. 4, 2020.

(51) Int. Cl. F21V 8/00; G02F 1/01

(52) U.S. Cl. CPC G02B 6/005; G02F 1/0136; G02B 6/0056

(57) ABSTRACT

A display panel has an array of pixels backlighted by a backlight including a lightguide and a plurality of out-coupling gratings. The locations of the out-coupling gratings are coordinated with positions of pixels in the array of pixels. The backlight may include a light-conducting transparent slab or an array of linear waveguides running parallel to the rows of the pixel array, with the gratings formed in the slab or in the waveguide. Wavelength composition and polarization of the light emitted by the waveguide may be matched to the transmission spectral bands and transmission polarization of the display panel.

### REFERENCE TO RELATED APPLICATION

This application claims priority from U.S. Provisional Patent Application No. 63/121,494 entitled “Patterned Backlight for Display Panel”, filed on Dec. 4, 2020, and incorporated herein by reference in its entirety.

### TECHNICAL FIELD

The present disclosure relates to optical devices, and in particular to lightguides for backlighting visual display panels, visual display devices, visual display systems, and related methods.

### BACKGROUND

Visual displays are used to provide information to viewer(s) including still images, video, data, etc. Visual displays have applications in diverse fields including entertainment, education, engineering, science, professional training, advertising, to name just a few examples. Some visual displays, such as TV sets, display images to several users, and some visual display systems are intended for individual users. Head mounted displays (HMD), near-eye displays (NED), and the like are being used increasingly for displaying content to individual users. The content displayed by HMD/NED includes virtual reality (VR) content, augmented reality (AR) content, mixed reality (MR) content, etc. The displayed VR/AR/MR content can be three-dimensional (3D) to enhance the experience and, for AR/MR applications, to match virtual objects to real objects observed by the user.

Compact and efficient display devices are desired for head-mounted displays. Because a display of HMD or NED is usually worn on the head of a user, a large, bulky, unbalanced, inefficient, and/or heavy display device would be cumbersome and may be uncomfortable for the user to wear. Compact and efficient display devices require compact and efficient lightguides and display panels.

### BRIEF DESCRIPTION OF THE DRAWINGS

Exemplary embodiments will now be described in conjunction with the drawings, in which:

FIG. 1A is a side cross-sectional view of a visual display device including an array of light valve pixels coupled to a backlight of this disclosure;

FIG. 1B is a plan view of an embodiment of the backlight of FIG. 1A in a 1D+1D beam expander configuration;

FIG. 1C is a plan view of an embodiment of the backlight of FIG. 1A in a 2D beam expander configuration;

FIG. 2A is a top schematic view of a photonic integrated circuit (PIC) backlight of this disclosure;

FIG. 2B is a top schematic view of a portion of the backlight of FIG. 2A superimposed with a single RGB pixel of a display panel;

FIG. 2C is a three-dimensional schematic view of linear waveguides of the PIC backlight of FIG. 2A;

FIG. 3A is a side cross-sectional view of a backlight including a slab lightguide coupled to a plurality of grating out-couplers;

FIG. 3B is a top magnified view of chirped out-coupling polarization volume hologram (PVH) gratings usable in the backlight of FIG. 3A;

FIG. 3C is a side cross-sectional view of a display panel illustrating focusing of light beams extracted by gratings from a supporting waveguide and directed through pixels of a liquid crystal array;

FIG. 3D is a side cross-sectional view of a display panel using a backlight of this disclosure, the backlight including an array of microlenses downstream of the array of liquid crystal pixels;

FIGS. 3E and 3F are side cross-sectional view of a display panel using a backlight of this disclosure, the backlight including multiple-order diffraction gratings;

FIG. 4 shows spectral plots of out-coupling efficiency of the PVH gratings of FIG. 3B;

FIG. 5A is a side cross-sectional view of a dimmable patterned backlight including voltage-controlled out-coupling gratings;

FIG. 5B a side cross-sectional view of a dimmable patterned backlight including an array of tunable liquid crystal waveplates coupled to an out-coupling grating;

FIG. 6 is an exploded side cross-sectional view of a liquid crystal (LC) display panel with an integrated backlight substrate;

FIG. 7 is a side cross-sectional view of an LCD panel using polarization-based color filters;

FIG. 8 is a transmission spectrum of the polarization-based color filters of FIG. 7;

FIG. 9 is a flow chart of a method for increasing backlight efficiency;

FIG. 10A is a schematic view of a translucent display utilizing a backlight of this disclosure;

FIG. 10B is an optical diagram showing the succession of light propagation through the translucent display of FIG. 10A; and

FIG. 11 is a view of a head-mounted display of this disclosure.

### DETAILED DESCRIPTION

While the present teachings are described in conjunction with various embodiments and examples, it is not intended that the present teachings be limited to such embodiments. On the contrary, the present teachings encompass various alternatives and equivalents, as will be appreciated by those of skill in the art. All statements herein reciting principles, aspects, and embodiments of this disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

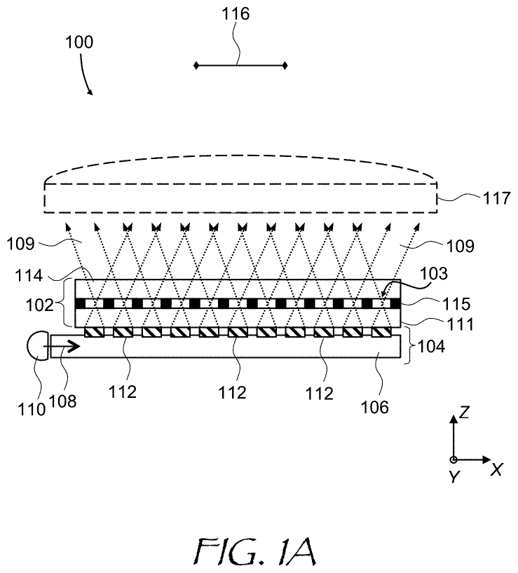

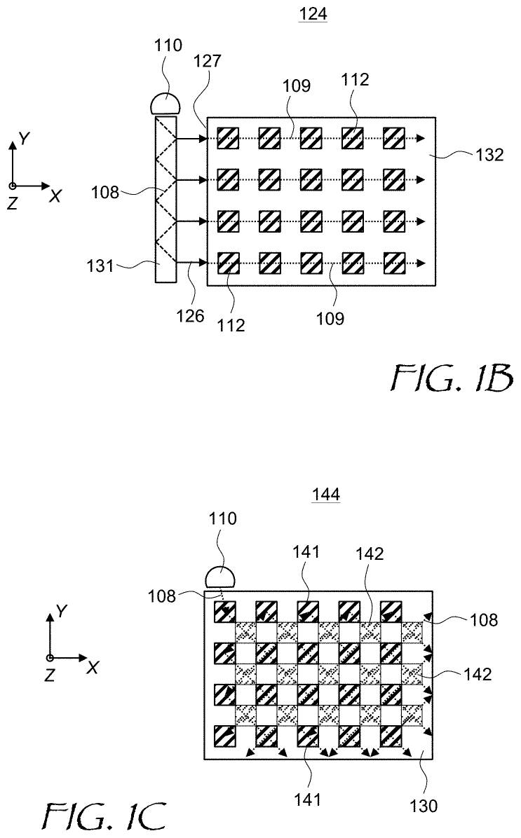

As used herein, the terms “first”, “second”, and so forth are not intended to imply sequential ordering, but rather are intended to distinguish one element from another, unless explicitly stated. Similarly, sequential ordering of method steps does not imply a sequential order of their execution, unless explicitly stated. In FIGS. 1, 3A-3B, and 5A-5B, similar reference numerals denote similar elements.

In a visual display including a panel of transmissive pixels coupled to a backlight, the efficiency of light utilization depends on a ratio of a geometrical area occupied by pixels to a total area of the display panel. For miniature displays often used in near-eye and/or head-mounted displays, the ratio can be lower than 50%. The efficient backlight utilization can be further hindered by color filters on the display panel which on average transmit no more than 30% of incoming light. On top of that, there may exist a 50% polarization loss for polarization-based display panels such as liquid crystal (LC) display panels. All these factors considerably reduce the light utilization and overall wall plug efficiency of the display, which is undesirable.

In accordance with this disclosure, the light utilization and the wall plug efficiency of a backlit display may be improved by providing a backlight including an array of points of light aligned with the individual pixels of the display panel. For example, a point source of light may be provided for each pixel and even for each color sub-pixel of an RGB display panel. The array of point sources may include an array of reflectors, e.g. small diffraction gratings, that out-couple portions of light carried by a waveguide of the backlight to propagate through individual pixels of the display panel.

A center wavelength of light emitted by the backlight may be selected to match the transmission wavelength of corresponding color filters, to increase the throughput. In displays where the backlight emits light of primary colors, e.g. red, green, and blue, a color filter layer may be omitted. Furthermore, for polarization-based displays, the polarization of the emitted light may be matched to the polarization transmitted by the pixels of the display panel. In other words, matching the spatial distribution, transmission wavelength, and the transmitted polarization characteristics of the pixels of the display panel enables one to considerably improve the portion of light that is not absorbed or reflected by the display panel on its way to the eyes of the viewer.

In accordance with the present disclosure, there is provided a display panel comprising an array of pixels disposed in a first plane, the pixels having a variable transmission of light, and a backlight optically coupled to the array of pixels for providing the light to the array of pixels. The backlight includes a lightguide for spreading the light along the first plane, and an array of gratings optically coupled to the lightguide for redirecting portions of the light in the lightguide to propagate perpendicular to the first plane and through pixels of the array of pixels. Positions of gratings of the array of gratings are coordinated with positions of pixels of the array of pixels, to increase a portion of light propagated through the array of pixels.

In some embodiments, the lightguide comprises a first portion for expanding the light along a first direction parallel to the first plane, and a second portion for expanding the light along a second, different direction parallel to the first plane. Gratings of the array of gratings are optically coupled to the second portion of the lightguide. In some embodiments, the lightguide comprises gratings configured for redirecting the light to propagate within the lightguide in a plurality of directions parallel to the first plane. Gratings of the array of gratings may be configured for focusing the redirected light portions through the pixels.

The display panel may further include an array of microlenses optically coupled to the array of pixels opposite to the backlight and configured to expand the redirected light portions propagated through the pixels. The array of microlenses comprises Pancharatnam-Berry phase (PBP) microlenses. In some embodiments, the array of gratings includes multi-diffraction order gratings configured to split the light portions into a plurality of diffraction orders, and to focus different diffraction orders of the plurality of diffraction orders through different pixels of the array of pixels, such that diffraction orders of different gratings of the array of gratings propagate through a same pixel of the array of pixels.

Gratings of the array of gratings may have a diffraction efficiency variable by applying an external control signal. The pitch of the array of gratings may be made equal to the pitch of the array of pixels. In some embodiments, array of pixels comprises a liquid crystal display (LCD) panel comprising an array of liquid crystal light valves. The LCD panel may include a liquid crystal layer between a pair of substrates. One of the substrates may include the backlight.

The backlight of a display panel of this disclosure may include a substrate and an array of linear waveguides supported by the substrate and running along pixels of the array of pixels. The array of gratings may be optically coupled to the array of linear waveguides for out-coupling the light portions propagating in the linear waveguides to propagate through corresponding pixels of the array of pixels. Gratings of the array of gratings may be formed in linear waveguides of the array of linear waveguides. Gratings of the array of gratings may be chirped for at least partially focusing the light redirected by gratings of the array of gratings to propagate through corresponding pixels of the array of pixels. An array of microlenses may be provided in an optical path between the array of gratings and the array of pixels, for at least partially focusing the light redirected by gratings of the array of gratings to propagate through corresponding pixels of the array of pixels.

The backlight of a display panel of this disclosure may include a slab of transparent material for propagating the light in the slab by a series of consecutive reflections from opposed surfaces of the slab. The array of gratings may be supported by the slab. Gratings of the array of gratings may be configured to diffract light of a first polarization and substantially not to diffract light of a second polarization orthogonal to the first polarization. The backlight may further include an array of tunable polarization rotators optically coupled to the slab in an optical path between the slab and the array of gratings. Individual tunable polarization rotators of the array of tunable polarization rotators may be configured to tune polarization of the light portions between the first and second polarizations by applying an external control signal, thereby controlling optical power of the light portions redirected by gratings of the array of gratings to propagate through corresponding pixels of the array of pixels.

In accordance with the present disclosure, there is provided a backlight for a display panel comprising an array of pixels disposed in a first plane, the pixels having a variable transmission of light. The backlight includes a substrate, an array of linear waveguides supported by the substrate and running along pixels of the array of pixels, and an array of gratings optically coupled to the array of linear waveguides for redirecting the light propagating in the array of linear waveguides to propagate perpendicular to the first plane and through pixels of the array of pixels. Positions of gratings of the array of gratings may be coordinated with positions of pixels of the array of pixels, to increase a portion of light propagated through the array of pixels.

In accordance with the present disclosure, there is further provided a method for a display panel comprising an array of pixels disposed in a first plane, the pixels having a variable transmission of light. The method includes selecting a spatial distribution of light redirecting elements of an array of light redirecting elements of the backlight to match a spatial distribution of pixels in the array of pixels of the display panel, for redirecting the light to propagate through individual pixels of the array of pixels. The method may further include selecting a spectral composition of the light redirected by the light redirecting elements to match spectral transmission of color filter elements of pixels of the array of pixels, and/or selecting a polarization of the light redirected by the light redirecting elements to match a transmission polarization of pixels of the array of pixels.

Referring now to FIG. 1A, a display 100 includes a display panel 102 coupled to a backlight 104. The display panel 102 includes an array of light valve pixels 103 (i.e. pixels having variable transmission) disposed in XY plane between top 114 and bottom 111 substrates. The display panel 102 may be e.g. a liquid crystal display (LCD) panel including an array of liquid crystal light valves 103. The backlight 104 includes a lightguide 106 configured to spread light 108 emitted by a light source 110 parallel to XY plane, i.e. along width and length dimensions of the display panel 102. The backlight 104 further includes an array of gratings 112 optically coupled to the lightguide 106. The gratings 112 redirect the light 108 propagating in the lightguide 106, forming an array of light beams 109 propagating through the pixels 103 of the array of pixels. Light transmission of the pixels 103 may be varied in a controllable fashion to display the required image by the display panel 102. The light beams 109 propagate predominantly perpendicular to XY plane, i.e. predominantly in Z-direction in FIG. 1.

Positions of the gratings 112 in the array are coordinated with positions of pixels 103 of the array of pixels, such that light beams 109 out-coupled by the gratings 112 propagate mostly through the pixels 103, and are substantially not blocked by boundaries 115 between the pixels 103. The arrays of pixels 103 and gratings 112 may be one-dimensional, e.g. extending along X- or Y-axis, or two-dimensional, i.e. extending along both X- and Y-axes. The spatial position of the gratings 112 may be selected to match the spatial position of the pixels 103 of the display panel 102. For example, a pitch of the array of gratings 112 may be an integer multiple of a pitch of the array of pixels 103. In the embodiment shown in FIG. 1, both pitches are equal, such that each grating 112 is disposed exactly under a corresponding pixel 103.

Individual light portions or light beams 109 split off by individual gratings 112 from the light 108 emitted by the light source 110 may be focused through individual pixels 103 as shown, to further lessen light losses at the boundaries 115 between the pixels 103. The expanding cones of light 109 downstream (higher in FIG. 1) of the display panel 102 may be collimated by an ocular lens 117 shown schematically in dashed lines, and directed at an eyebox 116 at an angle specific to each pixel 103. An image in angular domain is thus formed at the eyebox 116. Herein, the term “eyebox” means a geometrical area where an image of acceptable quality may be viewed by a user of the display.

The size of the eyebox 116 is proportional to a cone width of the light cones 109. Due to the display's geometry, the light cones width increases when a distance between the gratings 112 and the corresponding pixels 103 decreases. By reducing the distance between the gratings 112 and the corresponding pixels 103, the light cones may be made wider, and accordingly the eyebox 116 may be made bigger, e.g. by integrating the backlight 104 into the bottom substrate 111 of the display panel 102. More details on the integrated backlight will be provided further below.

Transmission values of individual pixels 103 may be set in accordance with the image to be displayed by the display 100. Brighter pixels of the image correspond to higher transmission values of the corresponding display panel pixels 103, and darker pixels of the image correspond to lower transmission values of the corresponding display panel pixels 103. In some embodiments, the gratings 112 may have a diffraction efficiency variable by applying an external control signal. The variability of the diffraction efficiency of the gratings 112 may be used to improve the overall contrast or dynamic range of the image. For example, the diffraction efficiency of the gratings 112 under pixels 103 with high transmission may be turned up to make a light area of the image appear even lighter, and the diffraction efficiency of the gratings 112 under pixels 103 with high transmission may be turned down to make a dark area of the image appear even darker. More details on the controllable gratings will be provided further below.

FIGS. 1B and 1C illustrate slab-type lightguide implementations of the backlight 104 of FIG. 1A. A backlight 124 of FIG. 1B includes the light source 110 coupled to a lightguide including two slab lightguide portions which expand the light 108 along two non-parallel directions by a series of consecutive reflections of the light 108 from outer parallel surfaces of a transparent slab substrate. First 131 and second 132 1D beam expanders expand the light 108 in Y- and X-directions respectively. The first 1D beam expander receives the light beam 108 from the light source 110 and produces a Y-expanded light beam 126, which is coupled into the second 1D beam expander 132 along an edge 127 parallel to Y-axis. The Y-expanded light beam 126 is then expanded by the second 1D beam expander 132 along X-axis, with light beam portions 109 propagated through and partially out-coupled by the gratings 112 optically coupled to the second 1D beam expander 132. Thus, the first 131 and second 132 1D beam expanders expand the light 108 along XY plane, which is parallel to the plane of the display panel 102 (FIG. 1A).

Referring specifically to FIG. 1C, a backlight 144 is an example implementation of the backlight 104 of FIG. 1A based on a slab lightguide. The backlight 144 of FIG. 1C includes the light source 110 coupled to a slab lightguide 130. The slab lightguide 130 includes first gratings 141, which are configured to out-couple the light portions to propagate through individual pixels of a pixel array, not shown. The slab lightguide 130 further includes second gratings 142, which are configured to redirect the light 108 to propagate within the lightguide 130 so as to expand in XY plane. It is to be understood that the light 108 expands in XY plane, i.e. propagates in XY plane, by a series of total internal reflections from outer parallel surfaces of the slab lightguide 130.

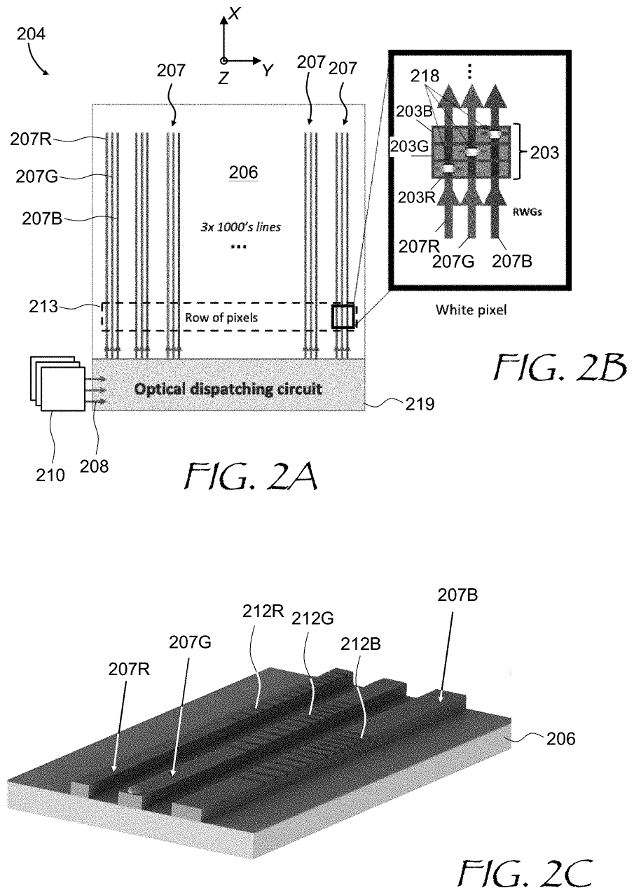

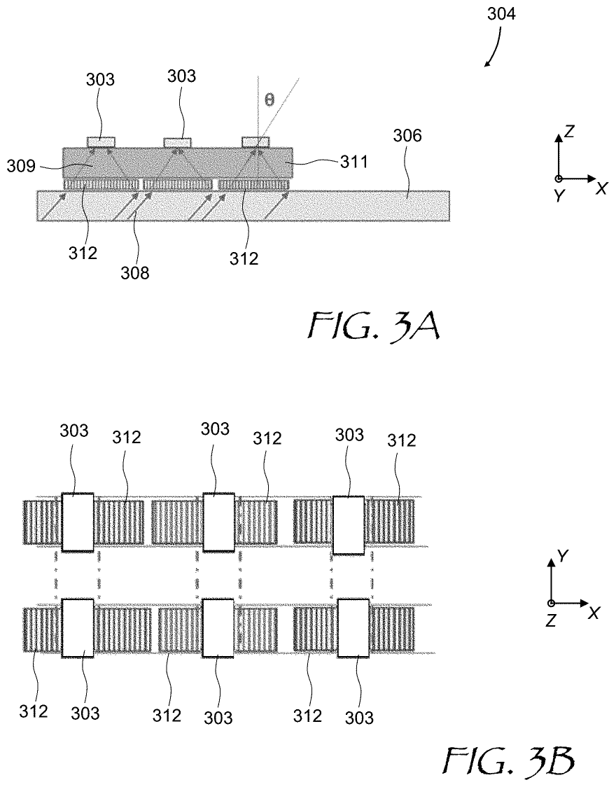

A linear waveguide implementation of the backlight 104 of FIG. 1A is shown in FIGS. 2A, 2B, and 2C. Referring first to FIGS. 2A and 2B, a photonic integrated circuit (PIC) backlight 204 includes a substrate 206 and an array of linear waveguides 207 supported by the substrate 206 and running along the array of pixels of a display panel, not shown. Herein, the term “linear waveguide” denotes a waveguide that bounds the light propagation in two dimensions, like a light wire. A linear waveguide may be straight, curved, etc.; in other words, the term “linear” does not mean a straight waveguide section. One example of a linear waveguide is a ridge-type waveguide.

In the PIC backlight 204 shown in FIG. 2A, the linear waveguides 207 include “red waveguides” 207R for conveying light at a red wavelength, “green waveguides” 207G for conveying light at a green wavelength, and “blue waveguides” 207B for conveying light at a blue wavelength. Light 208 at different wavelengths may be generated by a multi-wavelength light source 210 and distributed among different waveguides 207R, 207G, and 207B by an optical dispatch circuit 219, which is a part of the PIC. The function of the dispatch circuit 219 is to expand the light along Y-direction. One row of pixels of the display panel may be disposed across all the linear waveguides 207R, 207G, and 207B of red, green, and blue color channels respectively, the linear waveguides extending vertically in FIG. 2A. A row of pixels is outlined with dashed rectangle 213 in FIG. 2A.

FIG. 2B is a magnified view of three color channel waveguides under a single pixel of the display panel. Each of the three color sub-pixels corresponds to one of a red (R), green (G), and blue (B) color channel of the image, respectively. More than three color sub-pixels may be provided, e.g. in a RGGB scheme. Light portions may be out-coupled, or redirected, from the ridge waveguides 207R, 207G, and 207B by the respective gratings 212R, 212G, and 212B shown in FIG. 2C. The gratings 212R, 212G, and 212B may be chirped for focusing the out-coupled light beam in a direction along the waveguides, i.e. vertically in FIGS. 2A and 2B (along X-axis). Additionally, the grating groove can be curved, to focus light in the horizontal direction, in FIGS. 2A and 2B (i.e. along Y-axis). In the example of FIG. 2C, gratings 212R, 212G, and 212B are formed in linear waveguides 207R, 207G, and 207B respectively, although in some embodiments the array of gratings may be formed separately and optically coupled to the array of linear waveguides 207.

For focusing the out-coupled light beams in horizontal direction in FIG. 2B, 1D microlenses 218 may be provided as shown. Herein, the term “1D lenses” denotes lenses that focus light predominantly in one dimension, e.g. cylindrical lenses. 2D lenses, i.e. lenses focusing light in two orthogonal planes, may be provided instead of 1D lenses. The array of microlenses 218 disposed in an optical path between the gratings 212R, 212G, and 212B and the pixels 203R, 203G, and 203B may be used to at least partially focus of the light redirected by the gratings 212R, 212G, and 212B for propagation through corresponding pixels 203R, 203G, and 203B. The configuration is shown in FIG. 2B for one white pixel 203. The white pixel configuration may be repeated for each white pixel of the display panel.

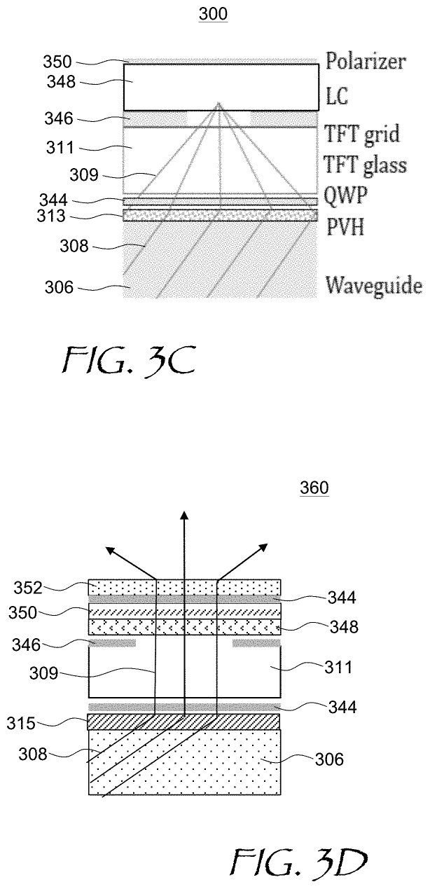

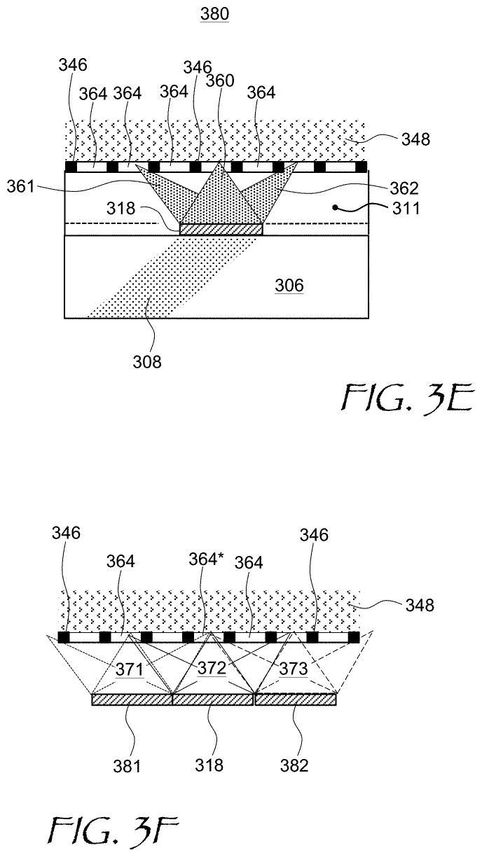

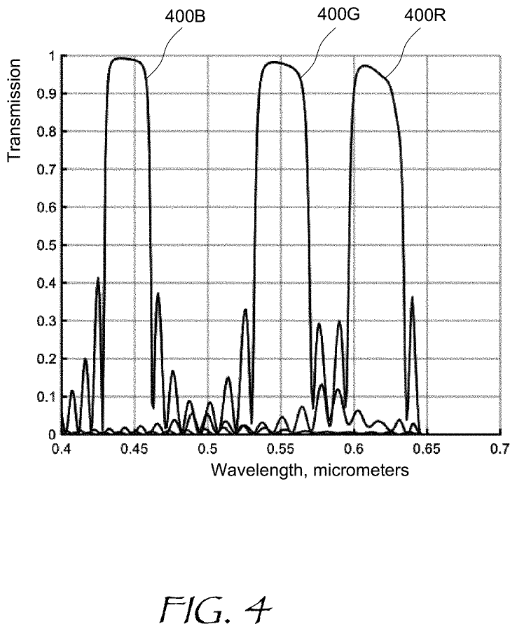

Referring to FIG. 3A, a backlight 304 of FIG. 3A is a slab-type lightguide implementation of the backlight 104 of the display 100 of FIG. 1A. The backlight 304 of FIG. 3A includes a slab 306 of transparent material, such as glass or plastic, acting as a light guiding substrate. Light 308 (shown with tilted arrows) propagates in the slab lightguide by a series of consecutive reflections, typically total internal reflections from the outer opposed parallel surfaces of the slab 306. Grating structures 312 provided on the slab 306 out-couple light of a corresponding color channel. By way of non-limiting examples, the grating structures 312 may include surface-relief gratings (SRGs), volume Bragg gratings (VBGs), polarization volume hologram (PVH) gratings, etc. The grating structures 312 may be chirped along X-axis, as illustrated in FIG. 3B, to provide 1D focusing (in XZ plane) of out-coupled light beams 309 through a substrate 311 and pixels 303 of the display panel. 2D focusing (in both XZ and YZ planes) may also be provided by chirping and/or curving of the grating grooves. Thinning down the substrate 311 enables one to increase the cone angle θ of the light beams 309, effectively increasing the size of the eyebox. An additional lens or lenses may be used for 1D/2D focusing or otherwise conditioning the out-coupled light beams 309.

The focusing of the light beams 309 by grating structures and/or additional microlenses on top of the grating structures is further illustrated in FIG. 3C, which shows a display 300 in a cross-sectional view. The display 300 includes the lightguide slab 306 supporting an array of PVH grating structures 313 configured to focus the light beams 309. Only one grating structure 313 is shown for brevity. An optional quarter-wave plate (QWP) 344 couples the PVH grating structures 313 to the substrate 311 (thin film transistor or “TFT” substrate) having a TFT grid 346 defining pixels in a LC layer 348 that is bound at the top side by a substrate (not shown) carrying a polarizer 350.

In operation, the PVH grating structures 313 out-couple portions of the light 308 and focus the out-coupled portions, forming the light beams 309. Each light beam 309 converges to propagate through a corresponding opening in the TFT grid 346 defining a light valve pixel. The maximum angle of bean convergence and subsequent divergence after the focal point defining an exit pupil size of the display 300 depends on a ratio of a width of the PVH grating structures 313 to a thickness of the substrate 311. Larger exit pupil size of the display 300 provides the user with more comfortable conditions of viewing. The convergence/divergence angle and associated exit pupil size may be increased by increasing the width of the PVH grating structures 313, reducing the substrate 311 thickness, or both. The PVH grating structure 313 width, however, is limited by the pixel pitch of the display 300, and the thickness of the substrate 311 is limited by the structural strength and/or flatness requirements of the substrate 311.

One way to overcome the beam divergence and associated exit pupil size limitation is to provide an array of microlenses on the display panel pixels at the opposite side of the backlight. Referring to FIG. 3D for a non-limiting example, a display 360 includes the lightguide slab 306 supporting an array of grating structures 315, in this example PVH configured to out-couple the light beams 309 without focusing, or with a moderate focusing. The optional quarter-wave plate (QWP) 344 couples the grating structures 315 to the substrate 311 (TFT substrate in this example) having a TFT grid 346 defining pixels in an LC layer 348. The LC layer 348 is bound at the top side by a substrate carrying a linear polarizer 350. The optional second QWP 344 may be disposed on the linear polarizer 350. An array of Pancharatnam-Berry phase (PBP) microlenses 352 may be disposed on top of the second QWP 344 to provide a desired divergence to the light beams 309 at polarization defined by the linear polarizer 350 and the second QWP 344. An array of refractive or diffractive microlenses may be used instead of the second QWP 344 and the PBP microlens array 352.

Another way to improve the focused beams convergence before the focal point at the pixel plane and divergence after the pixel plane is to use multiple order diffraction. Referring to FIG. 3E for a non-limiting example, a display 380 includes the lightguide slab 306 supporting an array of grating structures. Only one such grating structure 318 is shown in FIG. 3E for brevity. The grating structure 318 is a multi-diffraction order grating configured to split the impinging light 308 into a plurality of diffraction orders, including e.g. a 0^{th} order 360, a +1^{st} order 361, and a −1^{st} order 362. The different diffraction orders 360, 361, and 362 are focused through the TFT substrate 311 at different pixels 364 of the array of pixels defined by the TFT grid 346 controlling the LC layer 348.

FIG. 3F illustrates the combined effect the array of grating structures resulting in increasing the overall convergence and divergence angles. FIG. 3F depicts three adjacent grating structures of the array of grating structures, specifically the grating structure 318 surrounded by two grating structures 381 and 382 configured in the same way as the central grating structure 318, i.e. to produce at least three diffraction orders. The diffraction orders of the central grating structure 318 are shown in solid lines at 372, the diffraction orders of the left grating structure 381 are shown in short-dash lines at 371, and the diffraction orders of the right grating structure 383 are shown in long-dash lines at 373. One can see that diffraction orders of different gratings of the array of gratings may propagate through a same pixel of the array of pixels, thereby tripling the convergence angle at the pixel. For example, for a central pixel 364* corresponding to the central grating structure 318, the −1^{st} diffraction order of the left grating structure 371 adds with the 0^{th} order of the central grating structure 318 and with the 1^{st} diffraction order of the right grating structure 373. The convergence angle will be tripled for each pixel 364, tripling the overall divergence angle of the light beams exiting the pixels 364, and nearly tripling the resulting exit pupil size of the display 380.

The grating structures 312, 313, 315, and 318 may be polarization-selective. In other words, the grating structures 312 may be configured to diffract light of a first polarization and substantially not to diffract light of a second polarization orthogonal to the first polarization. For example, PVH gratings may be polarization-selective. PVH gratings may also be color-selective, as illustrated in FIG. 4. Each PVH grating may be configured to only diffract light within a certain wavelength band, e.g. in a red wavelength band 400R between 0.6 and 0.64 micrometers, a green wavelength band 400G between 0.525 and 0.575 micrometers, and a blue wavelength band 400B between 0.425 and 0.465 micrometers, as illustrated. The polarization selectivity of the PVH gratings may further improve the efficiency of backlight utilization.

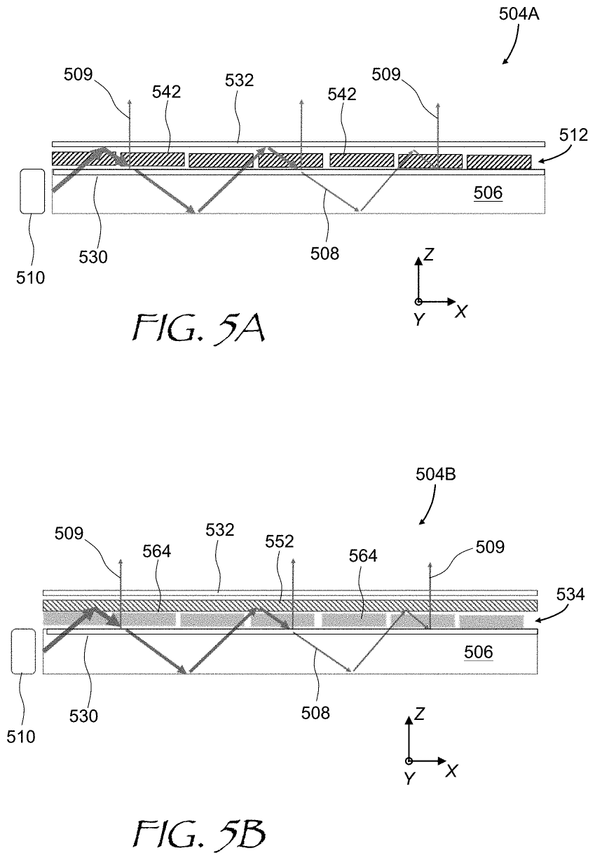

Referring now to FIG. 5A, a backlight 504A includes a lightguide plate or slab 506 supporting an active grating structure 512, which may be pixelated in 1D or 2D, i.e. it may include a 1D or 2D array of out-coupling gratings 542 disposed in XY plane. Illuminating light 508 provided by a light source 510 propagates in the slab 506 by a series of zigzag reflections from its opposed top and bottom surfaces. The illuminating light impinges onto the out-coupling gratings 542, which out-couple portions of the illuminating light 508, forming light beams 509. The out-coupling gratings 542 may be chirped and/or curved to make the light beams 509 converging. The efficiency of out-coupling by the grating structure 542 may be controllable by applying an external control signal, e.g. voltage across individual out-coupling gratings 542 of the grating structure 512. The voltage may be applied e.g. between a pixelated transparent electrode layer 530 supported by the slab 506 and a backplane top transparent electrode layer 532. This enables one to independently control the amount of light out-coupled by each out-coupling grating of the grating structure 512, or in other words, to control the brightness of a light beam illuminating a color sub-pixel, a pixel, or a sub-array of pixels of the display panel.

Turning to FIG. 5B, a backlight 504B is a variant of the backlight 504A of FIG. 5A, and includes similar elements. The backlight 504B of FIG. 5B includes a pixelated active liquid crystal (LC) waveplate 534 comprising individually tunable LC polarization rotators 564. A polarization-selective out-coupling grating 552 may be disposed on top of the active pixelated LC waveplate 534. The LC waveplate 534 may include, for example, a LC layer between the pixelated transparent electrode layer 530 and the backplane top transparent electrode layer 532. The polarization-selective out-coupling grating 552 may be configured to out-couple light of a certain pre-defined polarization state (“first polarization state”), and substantially to not out-couple light of an orthogonal polarization (“second polarization state”). The light 508 propagating in the lightguide plate may have one of the two polarization states. The active pixelated LC waveplate 534 is configured to switch or tune polarization of the light 508 in a spatially-selective manner. When the light propagated through the LC polarization rotators 564 is in the first polarization state, the light 508 is out-coupled as the light beam 509. When the light 508 propagated through the LC polarization rotators 564 is in the second polarization state, the light 508 is not out-coupled. When the light 508 propagated through the LC polarization rotators is in some intermediate polarization state, only a portion of that light is out-coupled as the light beam 509.

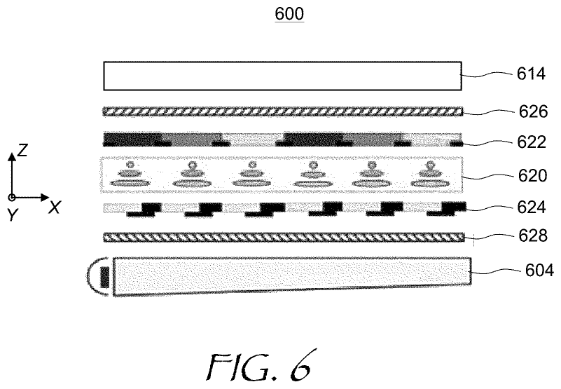

In some embodiments of this disclosure, a patterned backlight may be integrated into the display panel itself. For example, FIG. 6 illustrates an active matrix (AM) liquid crystal display (LCD) panel 600 including a twisted nematic (TN) LC layer 620 bounded by color filters layer 622 and thin film transistors (TFT) array 624. The color filter layer 622 and a top polarizer 626 are disposed on an inner surface of a top substrate 614. The TFT array 624 and a bottom polarizer 628 are supported by an inner surface of a lightguide panel (LGP) 604 including arrayed gratings, as disclosed herein. The absence of a separate bottom substrate in the LCD panel 600 enables one to reduce a distance from the LC layer 620 to the gratings of the LGP 604, allowing for a tighter focusing of the light redirected by the gratings onto the LC pixels, which increases the cone angle of the focused light. The increased cone angle results in the wider eyebox 116 of the display 100. This was explained above with reference to FIG. 1.

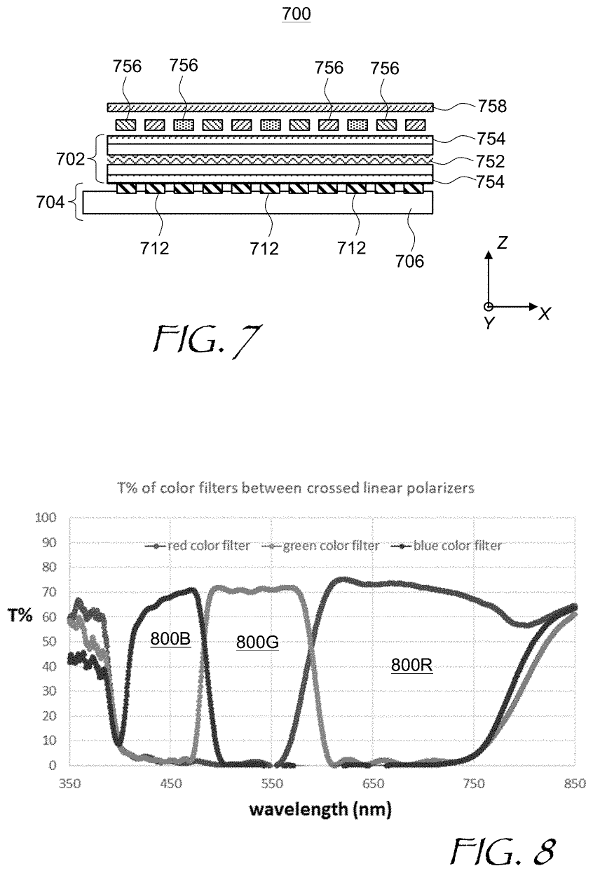

Referring now to FIG. 7, a visual display 700 includes a backlight 704, e.g. any backlight disclosed herein, coupled to an array of light valve pixels, e.g. an LC panel 702 including an LC layer 752 between spaced apart substrates supporting polarizers 754 on their outer sides. An array of color-selective waveplates 756, e.g. thick waveplates being a half-wave waveplate for one of red, green, and blue colors and an one-wave waveplate for the other two colors, is disposed downstream of the LC panel 702. Herein, the term “half-wave waveplate” includes waveplates with optical retardation of an odd number of half-waves of light at corresponding wavelength, and the term “one-wave waveplate” includes waveplates with optical retardation of an even number of half-waves of light. Positions of individual color-selective waveplates 756 in the array correspond to positions of individual pixels of the LC panel 702. An output polarizer 758 is disposed downstream of the array of color-selective waveplates 756.

In operation, the backlight 704 provides an array of light points corresponding the positions of individual pixels of the LC panel 702. The light points are provided by out-coupling gratings 712 on a lightguide 706, e.g. a PLC waveguide or a slab-type waveguide described above. The light reflected by the array of out-coupling gratings is spatially modulated by the LC panel 702. Different sub-pixels of the optical valve array of the LC panel 702 correspond to different color-selective waveplates. The color-selective waveplates provide a polarization phase retardation that rotates linear polarization of light by 90 degrees in a color-selective manner. The output polarizer 758 only selects light of a particular polarization, e.g. a polarization orthogonal to that of light exiting the LC panel 702. Together, the array of color-selective waveplates 756 and the output polarizer 758 form a polarization-based color filter array.

FIG. 8 illustrates transmission spectra of individual color-selective waveplates 756 of the visual display 700 of FIG. 7, including a red pixel transmission band 800R, green pixel transmission band 800G, and blue pixel transmission band 800B. The spectral shapes of the transmission bands 800R, 800G, and 800B are determined by the thickness and, optionally, the number and orientation of birefringent layers in each one of the color-selective waveplates 756.

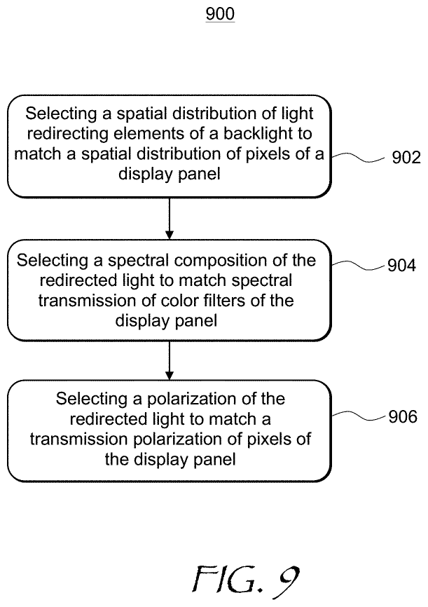

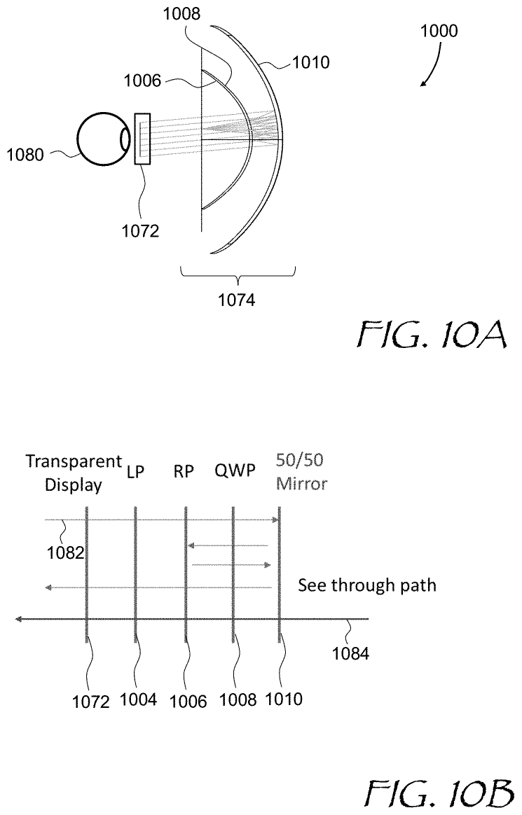

Turning to FIG. 9, a method 900 enables one to increase a portion of light emitted by a backlight and propagated through an array of pixels of a display panel, thereby improving efficiency of backlight utilization by the display system using the backlit display panel. The method 900 includes selecting (902) a spatial distribution of light redirecting elements of an array of light redirecting elements of the backlight to match a spatial distribution of pixels in the array of pixels of the display panel, for redirecting the light to propagate through individual pixels of the array of pixels. As explained above with reference to FIGS. 1, 3A-3B, and FIG. 7, this enables one to redirect individual light beams out-coupled by the redirecting elements (e.g. gratings) to propagate through individual pixels of the light valve pixel array. The method 900 may also include selecting (904) a spectral composition of the light redirected by the light redirecting elements to match spectral transmission of color filter elements of pixels of the array of pixels. For example, the spectral composition of light may be selected to include light at transmission wavelengths of the red 800R, green 800G, and/or blue 800B transmission bands of the transmission spectra shown in FIG. 8. This enables one to lessen absorption of light by the color filter elements, thereby improving overall efficiency of backlight utilization. The method 900 may further include selecting (906) a polarization of the light redirected by the light redirecting elements to match a transmission polarization of pixels of the array of pixels. This also facilitates reduction of optical losses in the display panel, improving overall backlight utilization efficiency.

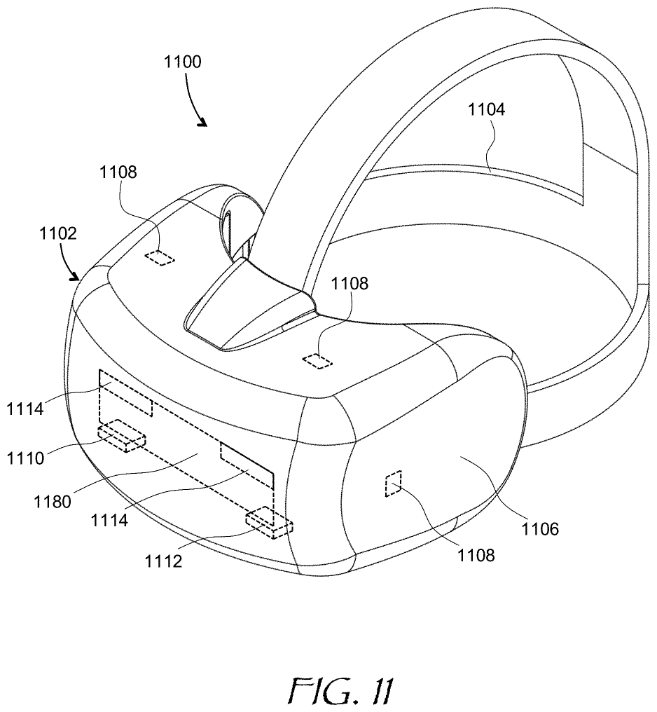

The backlights and displays of this disclosure may be configured to at least partially transmit light, which makes them suitable for augmented reality (AR) displays. Referring to FIGS. 10A and 10B, an AR display system 1000 (FIG. 10A) includes a display device 1072 such as, for example, the display 100 of FIG. 1 or any of its variants, the LC display 600 of FIG. 6, the visual display 700 of FIG. 7, etc. The display device 1072 is optically coupled to a pancake lens 1074 via a linear polarizer (LP) 1004 (FIG. 10B). The pancake lens 1074 includes sequentially disposed reflective polarizer (RP) 1006, a quarter-wave waveplate (QWP) 1008, and a 50/50 mirror 1010.

In operation, image light 1082 emitted by the display device 1072 in a direction of the pancake lens 1074 propagates through the linear polarizer 1004, the reflective polarizer 1006, and is reflected by the 50/50 mirror 1010. Since the 50/50 mirror 1010 is concave, the reflected image light 1082 gets partially collimated, propagates back through the QWP 1008, and changes its polarization to an orthogonal polarization. Then, the image light 1082 gest reflected by the reflective polarizer 1006, propagates again towards the 50/50 mirror 1010, gets reflected and collimated thereby, and changes its polarization back to the original polarization. Then, the image light 1082 propagates through the reflective polarizer 1006, the linear polarizer 1004, and the display device 1072, and towards the user's eye 1080. The polarization configuration of FIG. 10B ensures that the light path of the image light 1082 is folded twice, providing a very compact ocular lens for the display device 1072. Ambient light 1084 of a proper polarization can propagate directly through the pancake lens 1074 and the display device 1072.

Referring now to FIG. 11, an HMD 1100 is an example of a wearable display system which encloses the user's face, for a greater degree of immersion into the AR/VR environment. The HMD 1100 can present content to a user as a part of an AR/VR system. The system may further include a user position and orientation tracking system, an external camera, a gesture recognition system, control means for providing user input and controls to the system, and a central console for storing software programs and other data for interacting with the user for interacting with the AR/VR environment. The function of the HMD 1100 is to augment views of a physical, real-world environment with computer-generated imagery, or to generate the entirely virtual 3D imagery.

The HMD 1100 may include a front body 1102 and a band 1104. The front body 1102 is configured for placement in front of eyes of a user in a reliable and comfortable manner, and the band 1104 may be stretched to secure the front body 1102 on the user's head. A display system 1180 may include any of displays and/or backlights described herein. The display system 1180 may be disposed in the front body 1102 for presenting AR/VR imagery to the user. Sides 1106 of the front body 1102 may be opaque or transparent.

In some embodiments, the front body 1102 includes locators 1108, an inertial measurement unit (IMU) 1110 for tracking acceleration of the HMD 1100, and position sensors 1112 for tracking position of the HMD 1100. The locators 1108 are traced by an external imaging device of a virtual reality system, such that the virtual reality system can track the location and orientation of the entire HMD 1100. Information generated by the IMU and the position sensors 1112 may be compared with the position and orientation obtained by tracking the locators 1108, for improved tracking of position and orientation of the HMD 1100. Accurate position and orientation is important for presenting appropriate virtual scenery to the user as the latter moves and turns in 3D space.

The HMD 1100 may further include an eye tracking system 1114, which determines orientation and position of user's eyes in real time. The obtained position and orientation of the eyes allows the HMD 1100 to determine the gaze direction of the user and to adjust the image generated by the display system 1180 accordingly. In one embodiment, the vergence, that is, the convergence angle of the user's eyes gaze, is determined. The determined gaze direction and vergence angle may also be used for real-time compensation of visual artifacts dependent on the angle of view and eye position. Furthermore, the determined vergence and gaze angles may be used for interaction with the user, highlighting objects, bringing objects to the foreground, creating additional objects or pointers, etc. An audio system may also be provided including e.g. a set of small speakers built into the front body 1102.

Embodiments of the present disclosure may include, or be implemented in conjunction with, an artificial reality system. An artificial reality system adjusts sensory information about outside world obtained through the senses such as visual information, audio, touch (somatosensation) information, acceleration, balance, etc., in some manner before presentation to a user. By way of non-limiting examples, artificial reality may include virtual reality (VR), augmented reality (AR), mixed reality (MR), hybrid reality, or some combination and/or derivatives thereof. Artificial reality content may include entirely generated content or generated content combined with captured (e.g., real-world) content. The artificial reality content may include video, audio, somatic or haptic feedback, or some combination thereof. Any of this content may be presented in a single channel or in multiple channels, such as in a stereo video that produces a three-dimensional effect to the viewer.

Furthermore, in some embodiments, artificial reality may also be associated with applications, products, accessories, services, or some combination thereof, that are used to, for example, create content in artificial reality and/or are otherwise used in (e.g., perform activities in) artificial reality. The artificial reality system that provides the artificial reality content may be implemented on various platforms, including a wearable display such as an HMD connected to a host computer system, a standalone HMD, a near-eye display having a form factor of eyeglasses, a mobile device or computing system, or any other hardware platform capable of providing artificial reality content to one or more viewers.

The present disclosure is not to be limited in scope by the specific embodiments described herein. Indeed, other various embodiments and modifications, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A display panel comprising:
an array of pixels disposed in a first plane, the pixels having a variable transmission of light; and
a backlight optically coupled to the array of pixels for providing the light thereto, the backlight comprising:
a lightguide for spreading the light along the first plane; and
an array of gratings optically coupled to the lightguide for redirecting portions of the light in the lightguide to propagate perpendicular to the first plane and through pixels of the array of pixels;
wherein positions of gratings of the array of gratings are coordinated with positions of pixels of the array of pixels, to increase a portion of light propagated through the array of pixels.

2. The display panel of claim 1, wherein the lightguide comprises a first portion for expanding the light along a first direction parallel to the first plane, and a second portion for expanding the light along a second, different direction parallel to the first plane, wherein gratings of the array of gratings are optically coupled to the second portion of the lightguide.

3. The display panel of claim 1, wherein the lightguide comprises gratings configured for redirecting the light to propagate within the lightguide in a plurality of directions parallel to the first plane.

4. The display panel of claim 1, wherein gratings of the array of gratings are configured for focusing the redirected light portions through the pixels.

5. The display panel of claim 1, further comprising an array of microlenses optically coupled to the array of pixels opposite to the backlight and configured to expand the redirected light portions propagated through the pixels.

6. The display panel of claim 5, wherein the array of microlenses comprises Pancharatnam-Berry phase (PBP) microlenses.

7. The display panel of claim 1, wherein the array of gratings comprises multi-diffraction order gratings configured to split the light portions into a plurality of diffraction orders, and to focus different diffraction orders of the plurality of diffraction orders through different pixels of the array of pixels, such that diffraction orders of different gratings of the array of gratings propagate through a same pixel of the array of pixels.

8. The display panel of claim 1, wherein gratings of the array of gratings have a diffraction efficiency variable by applying an external control signal.

9. The display panel of claim 1, wherein the pitch of the array of gratings is equal to the pitch of the array of pixels.

10. The display panel of claim 1, wherein the array of pixels comprises a liquid crystal display (LCD) panel comprising an array of liquid crystal light valves.

11. The display panel of claim 10, wherein the LCD panel comprises a liquid crystal layer between a pair of substrates, wherein one of the substrates comprises the backlight.

12. The display panel of claim 1, wherein the lightguide of the backlight comprises:
a substrate;
an array of linear waveguides supported by the substrate and running along pixels of the array of pixels;
wherein the array of gratings is optically coupled to the array of linear waveguides for out-coupling the light portions propagating in the linear waveguides to propagate through corresponding pixels of the array of pixels.

13. The display panel of claim 12, wherein gratings of the array of gratings are formed in linear waveguides of the array of linear waveguides.

14. The display panel of claim 12, wherein gratings of the array of gratings are chirped for at least partially focusing the light redirected by gratings of the array of gratings to propagate through corresponding pixels of the array of pixels.

15. The display panel of claim 12, further comprising an array of microlenses in an optical path between the array of gratings and the array of pixels, for at least partially focusing the light redirected by gratings of the array of gratings to propagate through corresponding pixels of the array of pixels.

16. The display panel of claim 1, wherein the lightguide of the backlight comprises a slab of transparent material for propagating the light therein by a series of consecutive reflections from opposed surfaces of the slab, wherein the array of gratings is supported by the slab.

17. The display panel of claim 16, wherein gratings of the array of gratings are configured to diffract light of a first polarization and substantially not to diffract light of a second polarization orthogonal to the first polarization, the backlight further comprising an array of tunable polarization rotators optically coupled to the slab in an optical path between the slab and the array of gratings;
wherein individual tunable polarization rotators of the array of tunable polarization rotators are configured to tune polarization of the light portions between the first and second polarizations by applying an external control signal, thereby controlling optical power of the light portions redirected by gratings of the array of gratings to propagate through corresponding pixels of the array of pixels.

18. A backlight for a display panel comprising an array of pixels disposed in a first plane, the pixels having a variable transmission of light, the backlight comprising:
a substrate;
an array of linear waveguides supported by the substrate and running along pixels of the array of pixels; and
an array of gratings optically coupled to the array of linear waveguides for redirecting the light propagating in the array of linear waveguides to propagate perpendicular to the first plane and through pixels of the array of pixels;
wherein positions of gratings of the array of gratings are coordinated with positions of pixels of the array of pixels, to increase a portion of light propagated through the array of pixels.

19. A method for increasing a portion of light emitted by a backlight and propagated through an array of pixels of a display panel, the method comprising selecting a spatial distribution of light redirecting elements of an array of light redirecting elements of the backlight to match a spatial distribution of pixels in the array of pixels of the display panel, for redirecting the light to propagate through individual pixels of the array of pixels.

20. The method of claim 19, further comprising selecting at least one of:
a spectral composition of the light redirected by the light redirecting elements to match spectral transmission of color filter elements of pixels of the array of pixels; or
a polarization of the light redirected by the light redirecting elements to match a transmission polarization of pixels of the array of pixels.
